(19) United States
(12) Patent Application Publication
(10) Pub. No.: US 2020/0145830 A1
(43) Pub. Date: May 7, 2020

(54) DETECTION OF SURVEILLANCE DEVICE BY LONG-TERM EVOLUTION CLASSIFIER

(71) Applicant: Cisco Technology, Inc., San Jose, CA (US)

(72) Inventors: Huaiyi Wang, Cuyahoga Falls, OH (US); Qing Zhao, Fremont, CA (US); Matthew Aaron Silverman, Shaker Heights, OH (US)

(21) Appl. No.: 16/181,202

(22) Filed: Nov. 5, 2018

(51) Int. Cl. H04W 12/12; H04W 24/08

(52) U.S. Cl. CPC H04W 12/12; H04W 84/042; H04W 24/08

(57) ABSTRACT

In one embodiment, a method is performed. A classifier may receive a signal. The classifier may determine whether the signal passes a time-frequency filter. If the signal passes a time-frequency filter, the classifier may perform a search for at least one of a primary synchronization signal (PSS), a secondary synchronization signal (SSS), and/or a demodulation reference signal (DMRS) in the signal. The classifier may classify the signal based on a result of the search.

### TECHNICAL FIELD

The present disclosure generally relates to wireless communications.

### BACKGROUND

Surveillance devices, such as international mobile subscriber identity (IMSI) catchers, may be used to monitor cellular data devices, e.g., mobile telephones. An example surveillance device is the STINGRAY® surveillance radio, available from Harris Corporation of Melbourne, Fla. Such devices may be operated in a passive mode to analyze signals or in an active mode to simulate a cell site. In the active mode, a surveillance device may mimic a cell tower typically operated by a wireless carrier. Mobile telephones and other cellular data devices in the area may connect to the surveillance device. The operator of the surveillance device may then determine information regarding a mobile telephone or other devices connected to the surveillance device, such as a device location, phone number, or identifying information such as an IMSI number or an electronic serial number (ESN). The operator of the surveillance device may also be able to conduct a denial-of-service attack on a device connected to the surveillance device.

### BRIEF DESCRIPTION OF THE DRAWINGS

For an understanding of aspects of various embodiments described herein and to show how they may be carried into effect, reference is made, by way of example only, to the accompanying drawings.

FIG. 1 is a diagram that illustrates an example network.

FIG. 2 is a flow diagram illustrating an example process for classifying a signal.

FIG. 3 is a diagram that illustrates an example simulated monitoring process.

FIG. 4 is a diagram that illustrates an example cross-correlation search.

FIG. 5 is a diagram that illustrates an example eNodeB (eNB) transmission configuration determination.

FIG. 6 is a diagram that illustrates an example frame structure of a captured long-term evolution (LTE) frame.

FIG. 7 is a block diagram that illustrates an example server system.

### DESCRIPTION OF EXAMPLE EMBODIMENTS

### Overview

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example embodiments described herein.

Various embodiments disclosed herein may include devices, systems, and methods for classifying signals, such as pulses, received by a device. A signal may be classified as a valid long-term evolution (LTE) uplink or downlink signal, for example. The signal may be classified as potentially originating from a surveillance device based on, for example, a cell identifier and power transmission associated with the signal and/or detected mobility of the source of the signal. The signal may be classified as potentially originating from a surveillance device based on an abnormal switch in protocol, for example, from LTE to Global System for Mobile communications (GSM).

In an embodiment, a method is performed. A classifier may receive a signal. The classifier may determine whether the signal passes a time-frequency filter. If the signal passes the time-frequency filter, the classifier may perform a search for at least one of a primary synchronization signal (PSS), a secondary synchronization signal (SSS), and/or a demodulation reference signal (DMRS) in the signal. The classifier may classify the signal based on a result of the search.

### EXAMPLE EMBODIMENTS

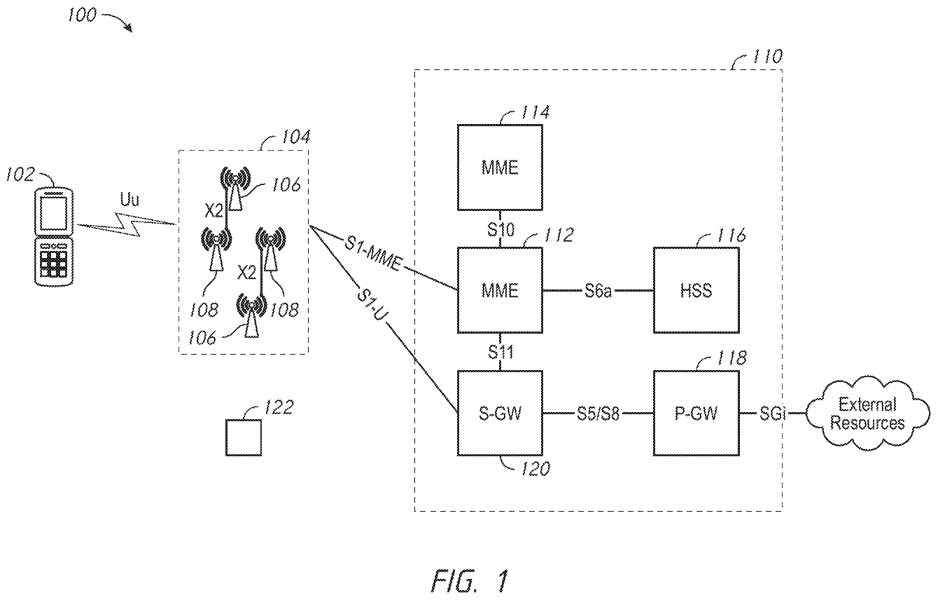

FIG. 1 illustrates an example long-term evolution (LTE) network 100. The LTE network 100 may include a user equipment (UE) device 102, such as a mobile telephone. It will be appreciated that the LTE network 100 typically includes multiple UE devices 102; however, one UE device 102 is depicted for purposes of simplicity.

The LTE network 100 may include an access network, e.g., an evolved universal mobile telecommunications system (UMTS) terrestrial radio access network (E-UTRAN) 104. The UE device 102 may communicate with the E-UTRAN 104 via a Uu interface. The E-UTRAN 104 may include one or more E-UTRAN Node B, also known as evolved Node B (abbreviated as eNodeB or eNB) entities 106. The E-UTRAN 104 may include one or more next generation NodeB (gNB) entities 108. The one or more gNB entities 108 may be in communication with the one or more eNB entities 106 via one or more X2 interfaces.

The LTE network 100 may include a core network, e.g., an evolved packet core (EPC) network 110. The E-UTRAN 104 may communicate with the EPC network 110 using an S1 interface, which may include an S1-MME interface and/or an S1-U interface. The EPC network 110 may include one or more mobility management entities (MMEs) 112, 114. The one or more MMEs 112, 114 may communicate with the E-UTRAN 104 via an S1-MME interface and may communicate with one another via an S10 interface. The one or more MMEs 112, 114 may control high-level operation of the LTE network 100 using signaling messages and a home subscriber server (HSS) 116, with which they may communicate via an S6a interface. The HSS 116 may serve as a central database that may include information regarding the network operator's subscribers.

The EPC network 110 may also include a packet data network (PDN) gateway (PGW) 118. The PGW 118 may communicate with external resources, e.g., servers and/or packet data networks, via the SGi interface. A serving gateway (SGW) 120 may communicate with the one or more MMEs 112, 114 using an S11 interface and with the E-UTRAN 104 using the S1-U interface. The SGW 120 may forward data between a base station and the PGW 118. The SGW 120 and PGW 118 may communicate with one another via an S5/S8 interface.

When the UE device 102 establishes a connection with the LTE network 100, an eNB entity 106 may select a MME, e.g., the MME 112 or the MME 114, with which the UE device 102 may register. If the UE device 102 has fifth generation (5G) capability, it may publish its 5G capability in non-access stratum (NAS) messaging. An MME that has 5G non-standalone architecture (NSA) capability may extract the capability information of the UE device 102 from the NAS messaging and may receive 5G subscription information for the subscriber from the HSS 116. A 5G-capable MME may assist in establishing 5G sessions in the LTE network 100.

A surveillance device 122 may be introduced near the LTE network 100 to monitor the UE device 102. The surveillance device 122 may be implemented, for example, as an international mobile subscriber identity (IMSI) catcher. An example IMSI catcher is the STINGRAY® surveillance radio, available from Harris Corporation of Melbourne, Fla. The surveillance device 122 may be operated in a passive mode to analyze signals communicated in the LTE network 100.

The surveillance device 122 may be operated in an active mode. In the active mode, the surveillance device 122 may simulate an eNB entity and attempt to cause the UE device 102 to connect to the surveillance device 122. If the surveillance device 122 is successful in causing the UE device 102 to connect to the surveillance device 122, the surveillance device 122 may obtain information regarding the UE device 102. For example, the surveillance device 122 may determine the location of the UE device 102 and may track the location of the UE device 102. The surveillance device 122 may determine identifying information associated with the UE device 102, including, for example, an IMSI number, an ESN, and/or a telephone number. The identifying information may be associated with a user of the UE device 102 and/or with a location of the UE device 102. Accordingly, the surveillance device 122 may be used to track the location and/or movements of users of UE devices. The surveillance device 122 may be used to determine the identities of users of UE devices in a gathering of people. A surveillance device 122 operating in the active mode may also be used to conduct a denial-of-service attack on the UE device 102.

The surveillance device 122 may attempt to cause the UE 102 to connect to the surveillance device 122 by transmitting a signal with a higher transmission power than the one or more eNB entities 106 and/or the one or more gNB entities 108. The UE device 102 may be configured to connect to the surveillance device 122 rather than an eNB entity 106 or a gNB entity 108 if the UE device 102 measures a stronger received signal strength indicator (RSSI) from the surveillance device 122. The surveillance device 122 may attempt to redirect the UE device 102 to an inferior or downgraded communication protocol, e.g., from LTE to 2G. Downgrading the UE device 102 may ensure an uninterrupted connection to the UE device 102, for example, when LTE coverage may not be guaranteed, or may facilitate intercepting communications to and from the UE device 102 due to reliance on weaker encryption.

In some embodiments, a classifier may detect a signal from the surveillance device 122. The classifier may be implemented, for example, as or as part of a wireless access point (AP) device, an eNB entity, and/or a gNB entity. A classifier may detect the surveillance device 122 by monitoring a cellular band of interest and measuring one or more metrics. For example, a duty cycle of 3G and/or 4G signals as compared with 2G signals may be measured. As disclosed herein, the surveillance device 122 may attempt to redirect UE devices connected to it to a downgraded communication protocol. Accordingly, a low duty cycle of 3G and/or 4G signals relative to 2G signals may indicate that a surveillance device is in use.

In some embodiments, a classifier may measure a power spectral density of a 3G and/or 4G downlink. In some embodiments, an occupied bandwidth may be measured to identify one or more symbols. If one or more of the metrics disclosed herein are outside typical operating bounds, it may be inferred that a surveillance device is present and/or being used. A notification may be sent to a network administrator.

In some embodiments, an LTE signal may be detected. For example, for LTE systems operating in a frequency division duplexing (FDD) mode (e.g., FD-LTE), paired radio frequency (RF) carriers may be used for downlink and uplink transmissions. The downlink and/or uplink frame structures may be consistent with a frame structure type 1. Ten consecutive (e.g., 1 ms) subframes may be dedicated to a single link direction in each 10 ms interval. A sensor may spend an amount of time monitoring one or more radio resources; this time may be known as a sensor dwell. FD-LTE frames that may be fully captured in a sensor dwell may be represented as a 10 ms pulse with a frequency bandwidth that may have various discrete values. This time-frequency property may be used to perform initial pulse filtering.

In some embodiments, for LTE systems operating in a time division duplexing (TDD) mode (e.g., TD-LTE), a frame structure type 2 may be applied to arrange downlink and uplink transmissions time slots over the extent of a 10 ms radio frame. A subframe (e.g., a special subframe) having a guard period (GP) with a duration between 1 and 10 orthogonal frequency division multiplexing (OFDM) symbols may be introduced between downlink and uplink transmissions conversion to avoid link collision. An OFDM symbol may be 66.7 μs in duration, excluding a cyclic prefix (CP). Depending, for example, on the frame format configuration, there may be one or two of these subframes in each TD-LTE frame. Accordingly, a single TD-LTE frame that may be fully captured in a sensor dwell may be represented as two or three pulses with various durations and frequency bandwidths. The durations and/or frequency bandwidths may be dependent on a configuration or configurations. This time-frequency property may be used to perform initial pulse filtering.

In some embodiments, an LTE downlink and/or an LTE uplink may be identified. A primary synchronization signal (PSS) and a secondary synchronization signal (SSS) may be used in LTE downlink transmissions to facilitate the system acquisition process. The PSS and SSS may be transmitted in each radio frame. The PSS and SSS may be physical signals that may be used by a classifier to identify LTE downlink frames and extract LTE system information from the downlink frames. This system information may include, for example, cell identity and a radio frame boundary. The duplex mode of the LTE system may be determined based on the relative positions of the PSS and the SSS in the radio frame.

An LTE uplink frame may be identified. Uplink transmissions may not have a dedicated synchronization signal design. In LTE systems, the uplink signals may be synchronized using the downlink signal. A sensor may monitor a communication process between an eNB entity and a UE device to decode signaling information and identify the LTE signal based on the decoded signaling information. Dwell captures for a sensor may not be continuous. Monitoring an entire communication process may involve a significant computational load on a sensor.

An uplink LTE signal may be identified separately from a downlink LTE signal using a physical random-access channel (PRACH) preamble, a demodulation reference signal (DMRS), and/or a sounding reference signal (SRS) that may be embedded in an LTE uplink frame. For example, a DMRS sequence may be used as a local reference signal to detect an uplink LTE signal. PRACH and/or SRS transmissions may be missing from one or more frames of an uplink LTE signal. Physical uplink control channel (PUCCH) and physical uplink shared channel (PUSCH) transmissions may (e.g., always) be accompanied by a corresponding DMRS.

The surveillance device 122 may not directly monitor communications between the UE device 102 and the one or more eNB entities 106 or the one or more gNB entities 108. For example, the surveillance device 122 may not directly capture and decode frames communicated to and from the UE device 102. The surveillance device may monitor communications to and from the UE device 102 by pretending to be an eNB entity and broadcasting one or more LTE frames with high transmit power and a proper system information block (SIB) or SIBs. This may motivate the UE device 102 to perform a handoff into their cell region. The surveillance device 122 may be identified by monitoring the configurations for LTE uplink and/or downlink transmissions.

For captured pulses, only partial information about the signal may be known. For example, partial information may be known regarding the duration and/or frequency bandwidth of a captured pulse. A sensor may not have prior information regarding a potential communication link available. A thorough search may be performed over (e.g., all possible) local reference signals initially, e.g., when searching for a primary synchronization signal (PSS). For downlink transmissions, performing a search over all possible local reference signals may be feasible because the number of possible local reference signals may be reasonable. As processing proceeds, information regarding the potential communication link, such as a cell identifier (cell ID), duplex mode, cyclic prefix (CP) length, symbol timing, and the like may be extracted and used. The number of local reference signal candidates that may be processed may be limited to a smaller group. Local reference signals may be orthogonal. A group search may reduce the number of sequences that may be searched.

For uplink transmissions, there may be many (e.g., tens of thousands) possible local DMRS candidates. Accordingly, performing a search over all possible local DMRS candidates may not be feasible. Even with sequence grouping, the searching time involved may be unreasonable in view of the processing capability of a sensor.

LTE channel information may be available at the sensor. The sensor may be aware of which LTE channel may be under scanning and the duplex mode of the LTE channel. Identifying a signal from the surveillance device 122 using local DMRS-based cross-correlation may not be feasible, for example, due to limitations associated with computing resources.

An LTE uplink transmission from the surveillance device 122 may be detected with a degree of confidence. For a TD-LTE channel under scanning, a classifier may determine that an uplink transmission is detected when a downlink transmission detection is confirmed. Time-frequency properties of the pulse and/or autocorrelation results may be used to determine the frame structure, cyclic prefix length, and/or symbol timing information of the uplink transmission. For a FD-LTE channel under scanning, a classifier may perform autocorrelation processing to a pulse that has passed the time-frequency filter to determine whether the pulse's configuration conforms to the configuration of an LTE specification. If the pulse's configuration does conform, the classifier may determine that it is likely that the pulse is an uplink transmission.

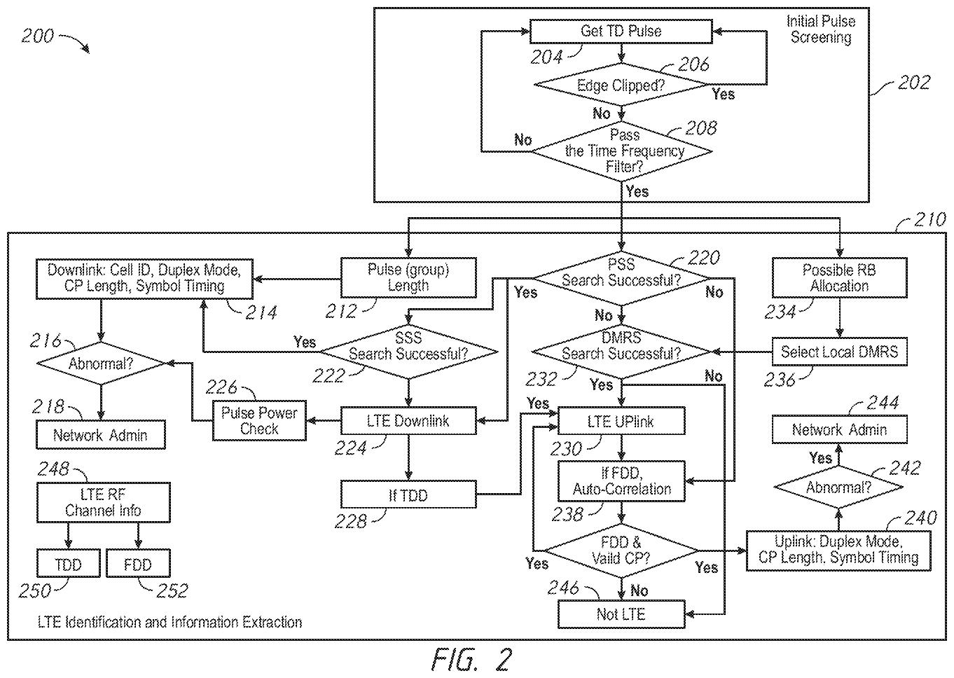

FIG. 2 is a flow diagram illustrating an example process 200 for classifying a signal. For clarity, routine processing operations, such as resampling, frequency offset estimation, frequency offset correction, soft automatic gain control (soft AGC), and the like, are not depicted. It will be appreciated that the sequence of operations depicted in FIG. 2 is presented by way of example only and is not intended to limit the scope of the disclosed subject matter. For example, unless otherwise noted, some operations may be performed in a different order than is depicted in FIG. 2. Some operations may be performed in parallel with other operations. Further, some operations may be omitted in some embodiments. Certain embodiment details may be varied, for example, in view of flexibility of hardware sampling rate, the information relating to an LTE transmission that may be used for high level processing, and/or the feasibility of the DMRS group search algorithm. For example, if only the FD-LTE downlink frame may be identified, the process 200 may stop when it is determined that the PSS search is successful. If obtaining certain cell ID information about the LTE eNB is desired, an SSS search may be performed. If the DMRS group search algorithm is performed, detection based on a cyclic prefix may be omitted. Otherwise, autocorrelation may be performed to detect the presence of a cyclic prefix. If a cyclic prefix is present, autocorrelation may be used to detect the length of the cyclic prefix.

A classifier may receive a signal, e.g., a pulse, and perform initial pulse screening at 202. For example, at 204, the classifier may receive a time division duplexing LTE (TD-LTE) pulse. At 206, the classifier may determine whether the pulse is edge clipped. If so, the classifier may return to 204 and wait to receive another TD-LTE pulse. If the pulse is not edge clipped, the classifier may determine whether the pulse passes a time-frequency filter at 208. For example, the classifier may determine whether the pulse is of at least a threshold duration and/or meets defined frequency criteria. If the pulse does not pass the time-frequency filter, the classifier may return to 204 and wait to receive another TD-LTE pulse.

If the pulse passes the time-frequency filter, the classifier may perform LTE identification and may extract information from the signal at 210. For example, at 212, the classifier may determine a pulse length or a pulse group length. Based on this determination, the classifier may identify the pulse as a downlink signal at 214. The classifier may then extract information from the pulse relating to one or more characteristics of the pulse, such as, for example, a cell ID, a duplex mode, a cyclic prefix (CP) length, and/or a symbol timing. At 216, the classifier may determine if any of these characteristics are abnormal, e.g., for a typical downlink signal in the network. If so, the classifier may send a notification to a network administrator at 218. The network administrator may take further action as appropriate.

If the pulse passes the time-frequency filter at 208, the classifier may search for a primary synchronization signal (PSS) at 220. This PSS search may be performed in parallel with the determination of the pulse length or pulse group length at 212. If a PSS is found at 220, the classifier may search for a secondary synchronization signal (SSS) at 222. If an SSS is found at 222, the classifier may identify the pulse as a downlink signal at 214. The classifier may then extract information from the pulse relating to one or more characteristics of the pulse, such as, for example, a cell ID, a duplex mode, a cyclic prefix (CP) length, and/or a symbol timing. At 216, the classifier may determine if any of these characteristics is abnormal, e.g., for a typical downlink signal in the network. If so, the classifier may send a notification to a network administrator at 218. The network administrator may take further action as appropriate.

If the PSS search at 220 is successful, e.g., if a PSS is found at 220, the classifier may identify the pulse as an LTE downlink signal at 224 regardless of the outcome of the SSS search at 222. For example, as shown in FIG. 2, the classifier may identify the pulse as an LTE downlink signal at 224 whether an SSS is found or no SSS is found at 222. At 226, the classifier may perform a pulse power check. If the power level of the pulse is abnormal, e.g., for a typical downlink signal in the network, the classifier may send a notification to a network administrator at 218. At 228, the classifier may determine whether the pulse is a time division duplexing (TDD) pulse.

If the classifier determines that the pulse is a TDD pulse at 228 and identifies a downlink signal at 224, the classifier may determine that an LTE uplink signal is present at 230. If the search for a PSS at 220 is unsuccessful, e.g., if no PSS is found, the classifier may search for a demodulation reference signal (DMRS) at 232. If the classifier finds a DMRS at 232, the classifier may determine that an LTE uplink signal is.

The classifier may identify the pulse as a possible resource block (RB) allocation at 234 if the pulse passes the time-frequency filter at 208. The classifier may make this identification at 234 in parallel with the determination of the pulse length or pulse group length at 212 and/or in parallel with the PSS search at 220. If the classifier identifies the pulse as a possible RB allocation at 234, the classifier may select a local DMRS candidate at 236 and search for a DMRS at 232.

If the classifier finds a DMRS at 232, it may identify the pulse as an LTE uplink signal at 230. At 238, the classifier may determine whether the pulse is a frequency division duplexing (FDD) pulse. The classifier may determine whether the pulse is an FDD pulse at 238 if the search for a PSS at 220 is unsuccessful. If the classifier determines that the pulse is an FDD pulse at 238, the classifier may perform autocorrelation processing to determine whether the pulse's configuration conforms to the configuration of an LTE specification, e.g., whether the pulse has a valid cyclic prefix (CP). If the pulse is an FDD pulse and has a valid CP, the classifier may identify the pulse as an uplink transmission at 240. The classifier may then extract information from the pulse relating to one or more characteristics of the pulse. These characteristics may include, for example, a duplex mode, a CP length, and/or a symbol timing. At 242, the classifier may determine if any of these characteristics is abnormal, e.g., for a typical uplink signal in the network. If so, the classifier may send a notification to a network administrator at 244.

If the classifier does not find a DMRS at 232, the classifier may determine that the pulse is not an LTE signal at 246.

In some embodiments, the classifier may determine LTE RF channel information at 248. For example, the classifier may identify the pulse as a TDD pulse at 250. The classifier may identify the pulse as an FDD pulse at 252.

The surveillance device 122 of FIG. 1 may attempt to exploit the cell search mechanism used in the LTE network 100 to capture nearby UE devices by exhibiting higher network quality. UE devices may be configured to connect to the eNB entity or the gNB entity that exhibits the highest apparent network quality and may therefore connect to the surveillance device 122. The surveillance device 122 may then cause a connected UE device to downgrade a protocol level to operate in GSM mode. The surveillance device 122 may cause a connected UE device to perform a cell handover.

Certain characteristics may suggest the presence of the surveillance device 122 in the vicinity of the LTE network 100 and may be used by the classifier to detect the surveillance device 122. For example, the surveillance device 122 may use an intermittent high power transmission to cause UE devices to perceive the surveillance device 122 as an eNB entity that could provide better service. The classifier may infer that such a transmission may originate from a surveillance device rather than from a legitimate eNB entity, for example.

An abnormal protocol switch, for example, from LTE to GSM may suggest the presence of a surveillance device. Accordingly, the classifier may infer that a signal may originate from a surveillance device if the signal indicates a configuration or command to cause a UE device to switch from LTE to GSM. This inference may be particularly strong if measurements (e.g., CSI measurements) indicate the presence of a good quality LTE signal.

Legitimate eNB entities and gNB entities are typically stationary. The classifier may infer that a signal may originate from a surveillance device if detected locations of captured LTE downlink signals are variable, indicating that the source of the signal is moving over time.

In some embodiments, an LTE classifier entity with a sensor (e.g., a monitor radio) may be implemented as part of a low-level infrastructure to monitor inappropriate privacy intrusions imposed by surveillance devices. For example, the LTE classifier entity may be implemented as part of an access point (AP) device.

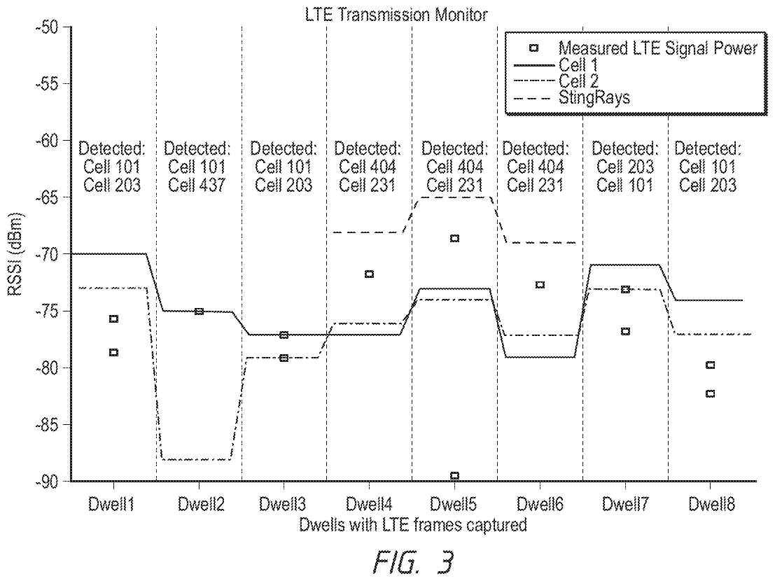

FIG. 3 is a diagram illustrating an example simulated monitoring process. The simulated monitoring process simulates the presence of multiple cell sites that may be identified by cell identities that may be represented as numbers, e.g., cell 101, cell 203, cell 231, cell 404, and cell 437. In the example illustrated in FIG. 3, two authorized eNB entities, associated with, e.g., cell 101 and cell 203, may serve a local region in a TDD mode. Other cell sites, e.g., cell 230 and cell 404, may be associated with an unauthorized entity, such as a surveillance device. An AP device or wireless LAN controller may monitor air conditions. For example, the AP device or wireless LAN controller may sense one or more radio resources over a period of time and may detect signals communicated in the region in one or more captured sensor dwells. For each detected pulse that may pass a time-frequency filter in a captured sensor dwell, a classifier may determine whether the pulse is an LTE frame and/or may determine one or more wireless features of the pulse, such as a measured signal power, e.g., a received signal strength indicator (RSSI).

In the process shown in FIG. 3, the classifier may have a sensor that may execute a search for a primary synchronization signal (PSS) and/or a secondary synchronization signal (SSS) to determine whether a detected pulse is a valid LTE frame. If so, the classifier may determine the cell identities of the eNB entity involved in the synchronized transmission. In some embodiments, the classifier may identify an eNB entity as either a legitimate, e.g., authorized, eNB entity, or an illegitimate or unauthorized eNB entity, such as a surveillance device, based on a determined cell identity and/or a measured signal power, e.g., RSSI. For example, the classifier may compare the determined cell identity with a list of authorized cell identities. The classifier may determine that an abnormally high RSSI value may be indicative of an unauthorized eNB entity, for example, if the RSSI value is high for a relatively short duration.

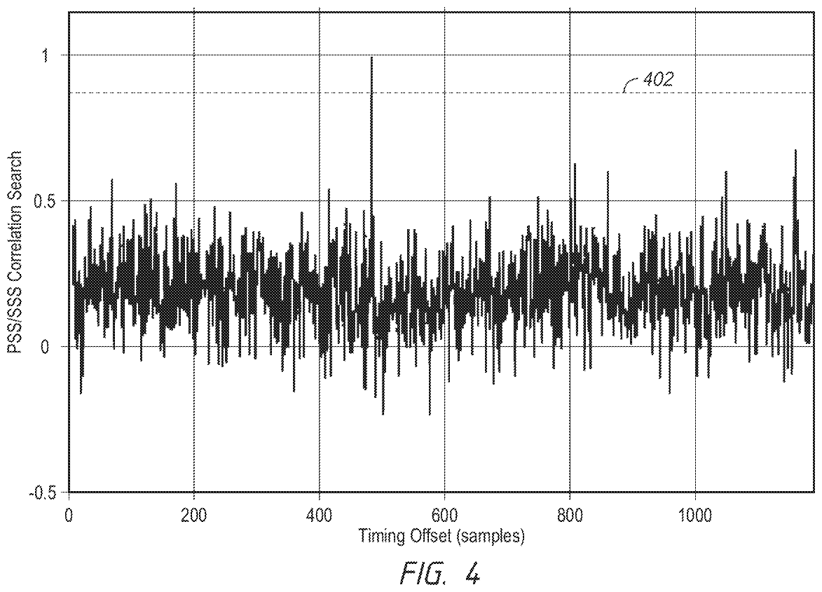

FIG. 4 shows an example cross-correlation search that may be performed to detect a PSS and/or an SSS. The diagram of FIG. 4 illustrates example cross-correlation values, e.g., ranging from −0.5 to 1, as a function of timing offsets. A pre-fast Fourier transform (pre-FFT) method may be used for the SSS search. A cross-correlation value above a threshold value 402 may indicate that a PSS and/or SSS may be located at the corresponding timing offset. When the cell identities are determined, cross-correlation tests may be performed to determine one or more probable (e.g., the most probable) eNB transmission configurations. These cross-correlation tests may be based on combinations of duplex modes (e.g., TDD or FDD) and cyclic prefix length (e.g., normal or extended) with the given determined cell IDs.

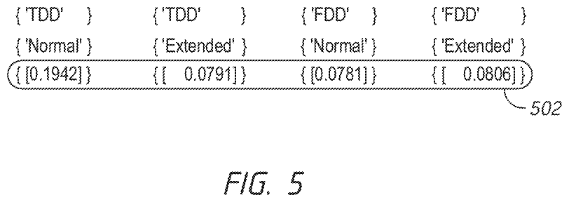

FIG. 5 illustrates an example eNB transmission configuration determination. A row 502 may show test results for the cell with the cell ID 101 in dwell 1 of FIG. 3. The captured transmission may be configured as a TD-LTE transmission with a normal cyclic prefix. Based on the frame structure (e.g., one or two link direction switches within a single frame), the classifier may determine the potential TDD configuration set.

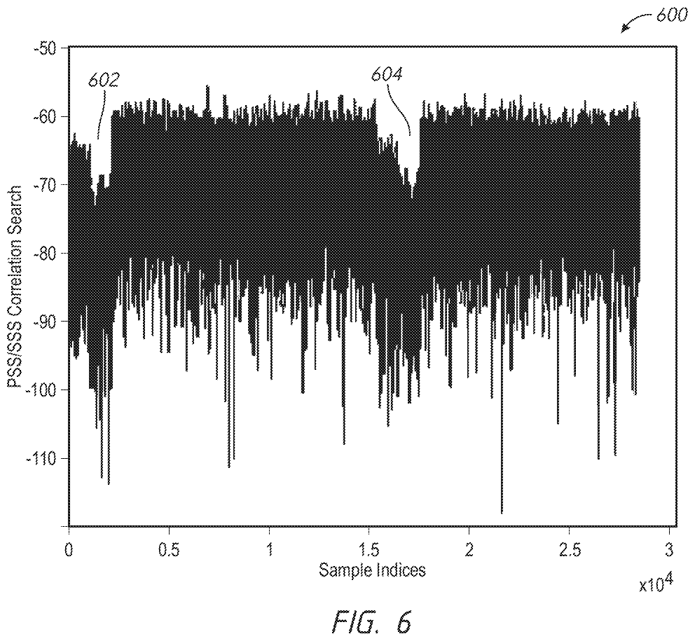

FIG. 6 is a diagram illustrating an example frame structure 600 of a captured LTE frame. The diagram of FIG. 6 illustrates observed signal amplitudes (e.g., on a decibel (dB) scale) as a function of sample indices, which may be representative of time. As shown in FIG. 6, the LTE frame may have two guard periods (GPs) 602, 604 with two link direction switches. Based on this example frame structure 600, the TDD configuration may be in the set {0, 1, 2, 6}, where the values in this set may correspond to standardized configurations that may determine or indicate the contents of one or more subframes of the captured LTE frame. The classifier may summarize and report this information to a higher layer network analyzer, e.g., for making a final decision as to whether the LTE frame is from an authorized eNB entity. The network analyzer may use historical records relating to locally observed LTE transmissions as an input in the decision making process.

In some embodiments, the classifier may record and report information regarding selected cells. For example, the classifier may record and report information about the two cells with the strongest transmissions, as determined by the peak magnitudes of the PSS and/or SSS cross-correlations.

Referring again to FIG. 3, in dwell 4, the classifier may detect a cell having a cell ID 404. Unlike cell 101 and cell 202, which may have stable detection records as shown in FIG. 3, the cell having the cell ID 404 may appear and disappear over a relatively short period of time and with a high transmission power. Accordingly, based on the cell ID and transmission power associated with the detected signal, the classifier may regard this newly present service provider as a potential surveillance device rather than an authorized eNB entity. The likelihood that the cell having cell ID 404 may be a surveillance device may increase if other information suggests that the cell having cell ID 404 may be a surveillance device. Such information may include, for example, detected subsequent lower protocol GSM transmission, available location information for authorized LTE eNB entities, mobility information (e.g., changing location information) of the cell in question, abnormal information for reselection to other cells while a monitor indicates a good air condition, and/or anomalous transmission configurations. Anomalous transmission configurations may include, for example, dominating uplink transmissions in the network, and the like.

One or more embodiments disclosed herein may assume that a flexible sampling scheme may not be available for the hardware and software platform. For example, a sensor may support standard sampling rates, e.g., 20 million samples per second (Msps), 40 Msps, or 80 Msps. A sampling rate used for LTE signal decoding may be difficult to obtain through resampling. In some embodiments, if a flexible sampling rate is available, a post-FFT SSS search may be adopted for better performance. Broadcast channel (BCH) decoding may be performed to check the cell re-election offset and neighbor list. More detailed transmission configuration information may be decoded from downlink control information (DCI). Additional information about an LTE signal may be determined as more hardware feature information becomes available.

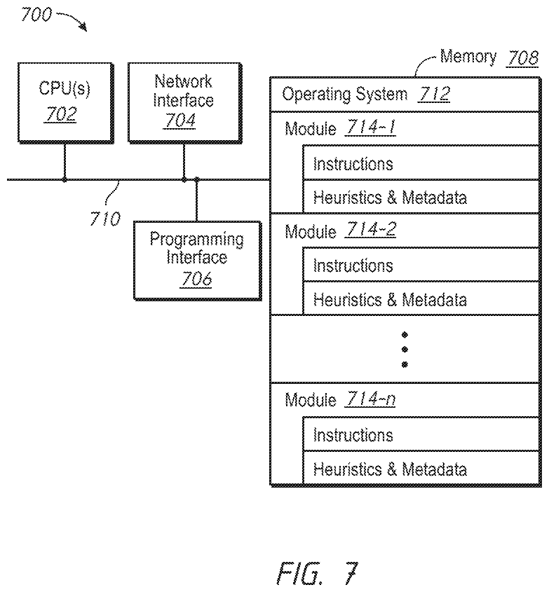

FIG. 7 is a block diagram of an example server system 700 enabled with one or more components of a device, server, or system in accordance with some embodiments. While certain specific features are illustrated, those of ordinary skill in the art will appreciate from the present disclosure that various other features have not been illustrated for the sake of brevity, and so as not to obscure more pertinent aspects of the embodiments disclosed herein. To that end, as a non-limiting example, in some embodiments the server system 700 may include one or more processing units (CPUs) 702, a network interface 704, a programming interface 706, a memory 708, and one or more communication buses 710 for interconnecting these and various other components.

The network interface 704 may be provided to, among other uses, establish and/or maintain a metadata tunnel between a cloud-hosted network management system and at least one private network including one or more compliant devices. In some embodiments, the one or more communication buses 710 may include circuitry that interconnects and controls communications between system components. The memory 708 may include one or more of high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. The memory 708 may include one or more storage devices remotely located from the one or more CPUs 702. The memory 708 may comprise a non-transitory computer readable storage medium.

In some embodiments, the memory 708 or the non-transitory computer readable storage medium of the memory 708 may include (e.g., store) the following programs, modules, and data structures, or a subset thereof including one or more of an operating system 712 or various modules 714-1, 714-2, . . . , 714-n. The modules 714-1, 714-2, . . . , 714-n, individually and/or collectively, perform one or more of the operations described herein. To that end, in various embodiments, the modules 714-1, 714-2, . . . , 714-n may include respective instructions and/or logic, and heuristics and metadata.

Various aspects of embodiments within the scope of the appended claims are described above. It should be apparent that the various features of embodiments described above may be embodied in a wide variety of forms and that any specific structure and/or function described above is merely illustrative. Based on the present disclosure, one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the second node are renamed consistently. The first node and the second node are both nodes, but they are not the same node.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
receiving a signal by an evolved Node B, a next generation Node B, or a wireless access point;
determining whether the signal passes a time-frequency filter;
on a condition that the signal passes the time-frequency filter, performing a search for at least one of a primary synchronization signal (PSS), a secondary synchronization signal (SSS), or a demodulation reference signal (DMRS) in the signal; and
classifying the signal based on a result of the search.

2. The method of claim 1, further comprising determining whether the signal is a valid long-term evolution (LTE) signal based on the search for the at least one of the PSS or the SSS.

3. The method of claim 1, wherein classifying the signal based on the result of the search comprises classifying the signal as a downlink signal on a condition that a PSS is found.

4. The method of claim 1, further comprising:
classifying the signal as a long-term evolution (LTE) uplink signal on a condition that a DMRS is found.

5. The method of claim 1, further comprising determining a characteristic associated with the signal, the characteristic comprising at least one of a cell identifier, a duplex mode, a cyclic prefix (CP) length, or a symbol timing associated with the signal.

6. The method of claim 5, further comprising, on a condition that the determined characteristic is abnormal, sending a notification to a network administrator.

7. The method of claim 1, further comprising classifying the signal as originating from a surveillance device based on a cell identifier and a transmission power associated with the signal.

8. The method of claim 1, further comprising classifying the signal as originating from a surveillance device based on mobility information associated with a cell identifier.

9. The method of claim 1, further comprising:
performing autocorrelation processing on the signal; and
determining whether the signal has a valid cyclic prefix (CP) based on the autocorrelation processing.

10. A device comprising:
a network interface in communication with a network;
a processor configured to execute computer readable instructions included on a non-transitory memory; and
the non-transitory memory including computer readable instructions, that when executed by the processor, cause the device to
receive a signal, wherein the device is an evolved Node B, a next generation Node B, or a wireless access point;
determine whether the signal passes a time-frequency filter;
on a condition that the signal passes the time-frequency filter, perform a search for at least one of a primary synchronization signal (PSS), a secondary synchronization signal (SSS), or a demodulation reference signal (DMRS) in the signal; and
classify the signal based on a result of the search.

11. The device of claim 10, wherein the computer readable instructions cause the device to determine whether the signal is a valid long-term evolution (LTE) signal based on the search for the at least one of the PSS or the SSS.

12. The device of claim 10, wherein classifying the signal based on the result of the search comprises classifying the signal as a downlink signal on a condition that a PSS is found.

13. The device of claim 10, wherein the computer readable instructions cause the device to: classify the signal as a long-term evolution (LTE) uplink signal on a condition that a DMRS is found.

14. The device of claim 10, wherein the computer readable instructions cause the device to determine a characteristic associated with the signal, the characteristic comprising at least one of a cell identifier, a duplex mode, a cyclic prefix (CP) length, or a symbol timing associated with the signal.

15. The device of claim 14, wherein the computer readable instructions cause the device to, on a condition that the determined characteristic is abnormal, send a notification to a network administrator.

16. The device of claim 10, wherein the computer readable instructions cause the device to classify the signal as originating from a surveillance device based on a cell identifier and a transmission power associated with the signal.

17. The device of claim 10, wherein the computer readable instructions cause the device to classify the signal as originating from a surveillance device based on mobility information associated with a cell identifier.

18. The device of claim 10, wherein the computer readable instructions cause the device to: perform autocorrelation processing on the signal; and
determine whether the signal has a valid cyclic prefix (CP) based on the autocorrelation processing.

19. A non-transitory computer readable storage medium storing one or more programs, the one or more programs comprising instructions, that, when executed by a computing device with a non-transitory memory and one or more processors, cause the computing device to perform or cause performance of:
receiving a signal, wherein the computing device is an evolved Node B, a next generation Node B, or a wireless access point;
determining whether the signal passes a time-frequency filter;
on a condition that the signal passes the time-frequency filter, performing a search for at least one of a primary synchronization signal (PSS), a secondary synchronization signal (SSS), or a demodulation reference signal (DMRS) in the signal; and
classifying the signal based on a result of the search.

20. The non-transitory computer readable storage medium of claim 19, wherein the instructions cause the computing device to determine a characteristic associated with the signal, the characteristic comprising at least one of a cell identifier, a duplex mode, a cyclic prefix (CP) length, or a symbol timing associated with the signal.
